(19) United States
(12) Patent Application Publication
(10) Pub. No.: US 2014/0341736 A1
(43) Pub. Date: Nov. 20, 2014

(54) SAIL WIND TURBINE

(71) Applicant: Jon Jay Howard, Joshua Tree, CA (US)

(72) Inventor: Jon Jay Howard, Joshua Tree, CA (US)

(21) Appl. No.: 14/448,419

(22) Filed: Jul. 31, 2014

Related U.S. Application Data
(63) Continuation-in-part of application No. 13/010,553, filed on Jan. 20, 2011, now abandoned.
(60) Provisional application No. 61/297,460, filed on Jan. 22, 2010.

(51) Int. Cl. F03D 3/06

(52) U.S. Cl. CPC F03D 3/067
USPC 416/132 B

(57) ABSTRACT

A sail wind turbine system includes a vertical main shaft with a vertical axis of rotation with parallel horizontal yardarms, cross-connected and corner braced, to the vertical main shaft. A sail assembly is included that comprises rectangular sails in frames fixedly attached at the tip of parallel horizontal yardarms. An outer support structure made of vertical columns with lateral cross bracing, joins together at the vertical main shaft in the middle and top, and is coupled thereto with self-aligning split bearings. The support columns are anchored to the ground, thereby providing more support to the structure. Thus, the present invention is an improved technique for providing wind power to produce electrical energy at ground level.

### CROSS-REFERENCE TO RELATED APPLICATIONS

This is a Continuation-in-Part application of U.S. Ser. No. 13/010,553, filed on Jan. 20, 2011, entitled, “Square Rigged Sail Wind Turbine”, which is a non-provisional application of U.S. Provisional Application No. 61/297,460, filed on Jan. 22, 2010, and entitled, “Square Rigged Sail Wind Turbine.”

### BACKGROUND CO THE INVENTION

1. Field of Invention

The present invention relates to wind turbines and, more particularly, to a vertical-axis wind turbine that is a sail wind turbine.

2. Description of Related Art

There is a need expressed to accommodate the populace of the planet With usable renewable electrical energy. For example, solar, wind, and geothermal power have been identified as energy sources that can be used to generate electricity. While some regions of the planet include vast sources of geothermal power, many regions of the planet are not as fortunate. Although solar and wind sources suffer from the problem of being intermittent in nature, recent advancements in technologies have made wind and solar energy an attractive and economically feasible solution to fulfill the deficiency in electrical power sources on the planet. Although solar energy may be an attractive renewable energy source, this application is directed to wind power.

For centuries wind power has been a source of energy and has been harnessed in various ways, with a clear distinction in the manner in Which wind energy is harnessed. In particular, there are horizontal-axis wind turbines and vertical-axis wind turbines.

In these modern times, the most common method for harnessing wind energy has been to use a horizontal-axis wind turbine. While horizontal-axis wind turbines have been promoted as being the more efficient type compared to other methods, they present several disadvantages. For example, horizontal-axis wind turbines have to be turned into the wind to start functioning. Also, they have a relatively high cut-in wind speed fur operation and a low cut-out wind speed. This allows fur only a relatively narrow window of operation, beyond which they are prone to damage. Another problem associated with the horizontal-axis design is that they typically require a gale force wind to produce power. Further, horizontal-axis wind turbines can be extremely high above a ground surface, making it difficult for technicians to perform much needed repairs. Due to such heights, technicians are largely exposed to grave risks as they provide maintenance service in adverse weather conditions.

As an alternative to the traditional wind turbine, vertical-axis wind turbines have been generated that change the axis of rotation of the turbine. The vertical-axis wind turbines improve the safety of servicing and maintenance duties as such services are performed much lower to the ground.

More specifically, in the 1920's, a French inventor by the name of Georges Jean Marie Darrieus designed a vertical-axis wind turbine that has been referred to as the “Darrieus design” or “eggbeater”. The Darrieus design uses a series of sails that are fixed at a set angle and arranged symmetrically around a vertical-axis. The symmetry of the sails provides a very effective means of generating a rotational force to the vertical shaft axis. Such vertical-axis wind turbines are used today on tall buildings to utilize the high wind velocity in higher altitudes. Unfortunately, sail fatigue, which causes premature failure of the system, is a common problem associated with the Darrieus design.

As an alternative to the Darrieus design, U.S. Pat. No. 4,449,053, issued to Kutcher, teaches a vertical-axis wind turbine that uses vertically positioned rotor blades. Blades are connected both at the top and bottom of a vertically extending rotor tube. While the Kutcher design does not includes sails that will fatigue, the vertically positioned rotor blades do easily capture wind at all angles, thereby reducing their effectiveness.

Another variation is the Giromill Cycloturbine, shown in U.S. Pat. No. 7,315,093, issued to Graham. The Giromill Cycloturbine has sails mounted such that the sails can rotate around an axis. The design of the Cycloturbine allows the sails to be pitched such that the sails are always at an angle relative to the wind. A main advantage to this design is that the torque generated remains almost constant over a fairly wide angle. Therefore, a Cycloturbine with three or four sails has a fairly constant torque. Predetermining the range of angles, the torque approaches a possible maximum torque, wherein the system generates more power. The system also has the advantage of being able to self start by pitching the down-wind moving sails flat to the wind to generate drag and start the turbine spinning at a low speed. One drawback to this design is that the sail pitching mechanism is complex and generally heavy, and a wind direction sensor must be added to the design in order to properly pitch the sails.

Currently, the commercial application of wind energy harnessing is primarily, if not exclusively, horizontal-axis wind turbines even though vertical-axis wind turbines avoid most of the disadvantages inherent in the horizontal-axis design. For example, vertical-axis wind turbines are omni-directional and have a lower cut-in wind speed and higher cut-out speed, thus making the window of operation wider. Also vertical-axis wind turbines have components that need servicing located at the bottom end of the structure making access more convenient. Vertical-axis wind turbines also allow for lower-ratio gearboxes, which are less expensive and more efficient than gearboxes needed to operate horizontal-axis wind turbines. Further, vertical axis wind turbines are able to operate at a higher wind speed and at lower risk of suffering wind damage. Finally, vertical-axis wind turbines adapt to a simpler design and construction.

Thus, there is a continuing need for a vertical-axis wind turbine that captures the inherent advantages of the vertical-axis design, yet improves upon the drawbacks of existing vertical-axis designs.

### SUMMARY OF INVENTION

While considering the failure of others to make use of all of the above components in this technology space, the inventor unexpectedly realized that a vertical-axis wind turbine with sails that are pivotally attached to parallel and horizontal yardarms would provide an improved design without the drawbacks of the prior art.

Thus, the present invention is directed to a square rigged sail wind turbine that includes one or more stacked sail assemblies. Each sail assembly includes a main shaft having a vertical axis of rotation, with each successive sail assembly in the stack sharing the main shaft or otherwise having main shafts that are connected such that they share the vertical axis of rotation. Each sail assembly includes one or more yard arms that extend horizontally from the main shaft For example, a first set of horizontal and parallel yardarms extend from the main shaft. A first and second sail are connected with and between the yardarms. The sails are attached with the yardarms such that the main shaft is central and positioned between the sails.

A second set of parallel yardarms can be included that extend from the main shaft approximately perpendicularly to the first set of parallel yardarms. In this aspect, the second set of parallel yardarms also includes two sails connected between each of the yardarms. Thus, although not limited thereto, in this aspect, the first sail assembly includes four sails.

Support columns and lateral supports are included to connect with the vertical main shaft and for anchoring with a ground surface to support the main shaft in a vertical orientation. At the bottom of the wind turbine is a main deck. Ball-joint four roller thrust bearing are included for positioning on the main deck, with the main shaft passing therethrough. The thrust bearings provide stability to the main shaft and support weight of the sail assemblies. Roller bearings are also positioned through the main deck. The main shaft passes through the thrust bearings and roller bearings, leaving a shaft stem that extends below the main deck. The shaft stem passes through the bearings to provide the power take off to a power take off system.

In another aspect, the sail wind turbine system includes a wind tunnel having an entrance and an exit, with the wind turbine positioned within the wind tunnel between the entrance and the exit. En yet another aspect, roll-up and down doors are attached with the entrance and exit.

In yet another aspect, fencing is attached around the support columns.

In another aspect, four roll-up and down doors are attached with the support columns.

Finally, as can be appreciated by one in the art, the present invention also comprises a method for forming and using the wind turbine described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is a perspective-view illustration of a frame structure for a single tier of a sail assembly for a wind turbine according to the present invention;

FIG. 1B is a perspective-view illustration of a set of sails for a single tier of a sail assembly for the wind turbine according to the present invention;

FIG. 1C is a perspective-view illustration of a single tier of the sail assembly for the wind turbine according to the present invention, depicting the sails as attached with the frame structure to complete the sail assembly;

FIG. 1D is a side view illustration of a single tier of a wind turbine according to the present invention, depicting a single sail assembly;

FIG. 2 is a top-view illustration of a sail assembly, showing the order in sequence of four rectangular sails in action;

FIG. 3 is a top-view illustration of a sail assembly of a wind turbine, showing the impact on the sails as wind approaches from an opposite direction of that depicted in FIG. 2;

FIG. 4A is a perspective-view illustration of a wind turbine constructed in accordance with the present invention, showing the relativity of an arrangement of sails in action;

FIG. 4B is a top-view illustration, depicting multiple tiers of sail assemblies as engaged by wind;

FIG. 5 is a side-view illustration of the wind turbine;

FIG. 6 is an illustration of power take-off and a power take-off system according to the present invention;

FIG. 7 is a side-view illustration of a wind turbine according to the present invention;

FIG. 8A is a top-view illustration, depicting two sails attached with the sail assembly structure;

FIG. 8B is a top-view illustration, depicting three sails attached with the sail assembly structure;

FIG. 9 is an illustration of opposite counter-rotating rotors with sail assemblies that rotate in opposite directions;

FIG. 10 is an illustration depicting another aspect of the wind turbine according to the principles of the present invention, where the sails are fixed;

FIG. 11 is an illustration depicting a roof attached over the wind turbine according to the principles of the present invention;

FIG. 12 is an illustration depicting fencing attached around the wind turbine according to the principles of the present invention;

FIG. 13 is an illustration depicting roll-up and down doors attached around the wind turbine according to the principles of the present invention;

FIG. 14 is an illustration depicting the wind turbine being positioned within a wind tunnel according to the principles of the present invention;

FIG. 15 is an illustration depicting the wind turbine being positioned within a and tunnel, with fencing positioned at an entrance and exit of the wind tunnel, according to the principles of the present invention; and

FIG. 16 is an illustration depicting a wind tunnel according to the principles of the present invention, with roll-up and down doors attached at the entrance and exit of the wind tunnel.

### DETAILED DESCRIPTION

The present invention relates to wind turbines and, more particularly, to a vertical-axis wind turbine that is a square rigged sail wind turbine. The following description is presented to enable one of ordinary skill in the art to make and use the invention and to incorporate it in the context of particular applications. Various modifications as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

The present invention is a vertical-axis wind turbine for generating electricity. In other words, the wind turbine is configured such that wind energy causes a series of sails to rotate about a vertical (or substantially vertical) axis. It should be understood that although the present invention is described with respect to wind and wind direction, it is not intended to be limited thereto as the turbine of the present invention can be also applied as a water-driven turbine with sails (or in the case of water, paddles) that are driven via a water current.

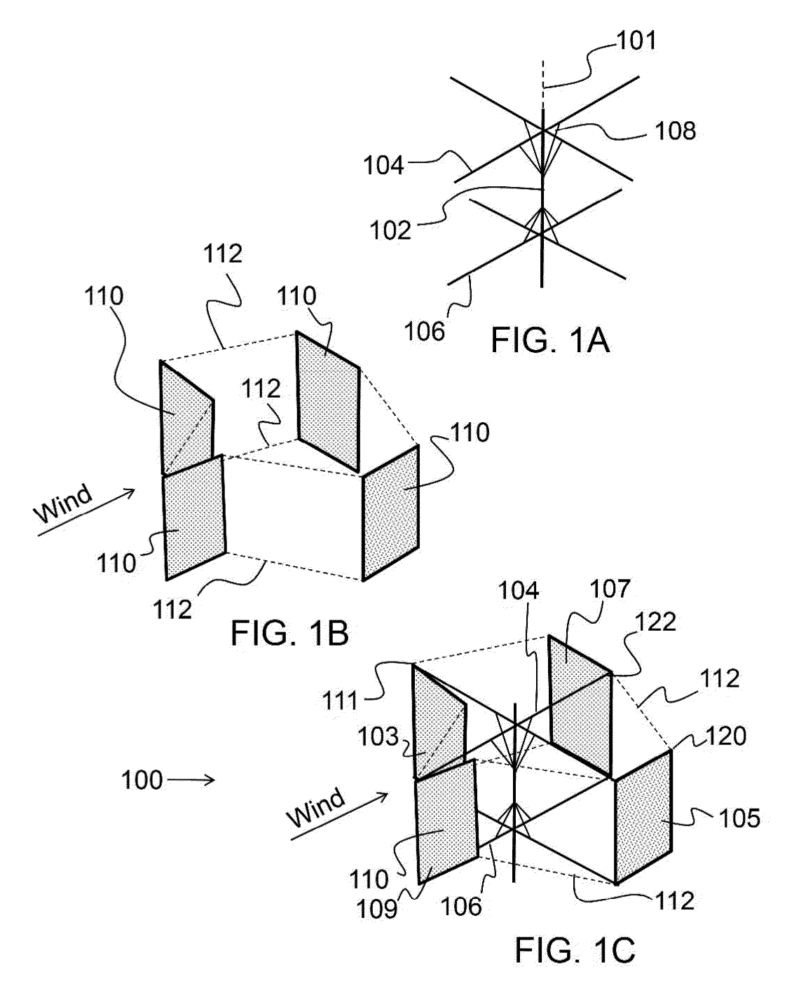

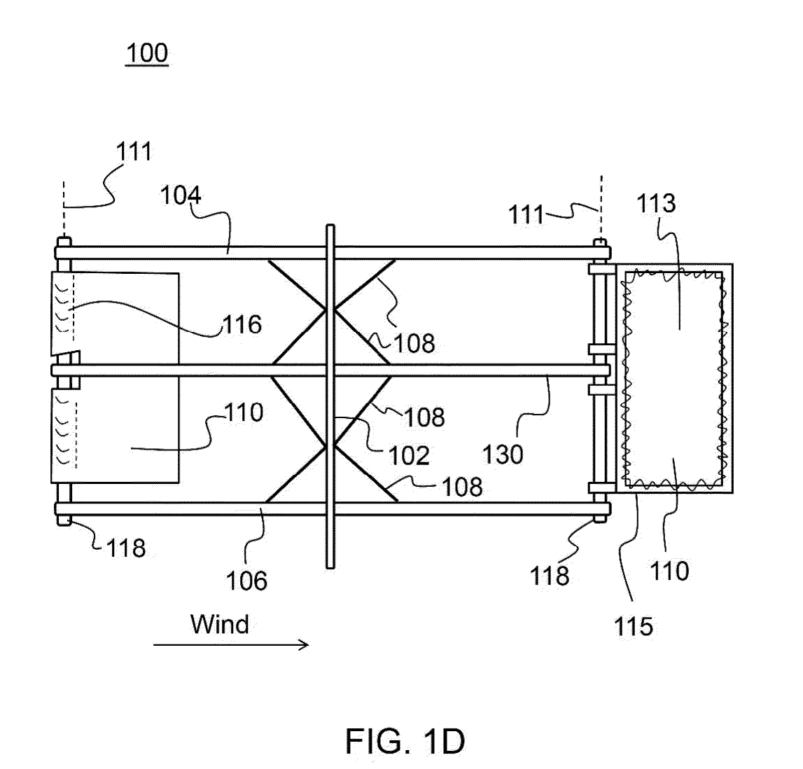

For an understanding of turbine construction and functionality, FIGS. 1A through 1C illustrate the construction of a single tier of the wind turbine according to the present invention. More specifically, FIGS. 1A through 1C illustrate the construction of an example sail assembly 100. As shown in FIG. 1A, the turbine includes a sail assembly having a central and vertical main shaft 102 (e.g., elongated rod) that has a vertical shaft axis 101 of rotation. The sail assembly includes a first, top yardarm 104 and a second, bottom yardarm 106 that extend horizontally from the main shaft 102 as parallel and horizontal yardarms. The yardarms 104 and 106 are secured with the main shaft 102 using any suitable technique. As a non-limiting example, the yardarms 104 and 106 are cross-connected and corner braced 108 to the vertical main shaft 102. It should also be noted that although the present invention describes both a top yardarm 104 and bottom yardarm 106, the invention is not limited thereto as any suitable number or configuration of the yardarms is within the scope of the present invention. For example, a single yardarm can be employed, Where the sail hangs from the yardarm and pivots about a pivot axis. However, as described above, it is desirable to have both a top yardarm 104 and bottom yardarm 106 to support the sails 110.

Additionally and as shown in FIG. 1B, the present invention uses a series of sails 110 that are formed to pivotally connect with the yardarms. As will be understood by the description below, each of the sails 110 also include lanyards 112 (depicted as the dashed lines) that are used to limit the motion of the sails 112.

FIG. 1C depicts the sails 110 as attached with the yardarms 104 and 106 to form the sail assembly 100. Each of the sails 110 (e.g., first 103, second 105, third 107, and fourth 109 sails) are pivotally attached with a tip of the yardarms 104 and 106 about a sail pivot axis 111. The sails 110 are pivotally attached with the yardarms 104 and 106 using any pivotal attachment technique. As a non-limiting example, each of the sails 110 is simply tied up to the tips of the yardarms 104 and 106. As yet another non-limiting example and as depicted in FIG. 1D, each of the sails 110 can be formed to include a sleeve therethrough 116. A rod 118 passes through the sleeve 116 and pivotally (rotatably) connects with each of the top yardarm 104 and bottom yardarm 106, thereby allowing the sails 110 to pivot about the sail pivot axis Ill while the yardarms 104 and 106 rotate about the shaft axis and rotate the main shall 102. As yet another non-limiting example, a cloth sail material 113 can be stitched to a sail frame 115 (to collectively form the sail 110) that is rotatably connected with each of the yardarms.

It should be noted that although the sail assembly 100 depicted in FIG. 1C has two parallel yardarms 104 and 106, the invention can be devised to have any suitable number of yardarms to support the sails 110. It should also be noted that the present invention can be devised to include multiple sets of parallel and horizontal yardarms that extend from the main shaft 102 on a single level. For example and as depicted in FIG. 1C, there are two sets (a first set and a second set) of parallel (top and bottom) yardarms that are approximately orthogonally (i.e., perpendicular) positioned with respect to one another (each set of yardarms having two sails 110).

As a non-limiting example and as depicted in FIG. 1D, the wind turbine and corresponding sail assembly 100 can be formed with a third parallel yardarm 130 with corner bracing 108 above and below respectfully, between each of the top and bottom parallel yardarms 104 and 106. In this aspect, each rectangular sail frame structure/assembly would have three parallel yardarms attached to the vertical main shaft 102.

Referring again to FIG. 1C, because the sails 110 are pivotally connected with the yardarms 104 and 106, the sails are blown by the wind to rotate about the sail pivot axis 111. As illustrated, the lanyards 112 connect the sail tip 120 with a yardarm tip 122 of neighboring yardarm 104 or 106. Each lanyard 112 serves to limit the motion of the corresponding sail 110. For example, a lanyard 112 can also be used to prevent the sails from opening past the 90 degree, margin. The lanyard 112 is any suitable item that can be affixed with the sail to prevent it from overextending or opening, a non-limiting example of which includes a rope, wire, bungee, chain, etc., that is affixed with an end of the sail 110 and some other point on the wind turbine, such as the point of attachment of an adjacent sail or the neighboring yardarm. In another aspect and as an alternative to the lanyard 112, an L-shaped angled stop can be used behind the pivotally attached sail frame structure to prevent the sails from opening further than 90 degrees (or any other desired angle setting).

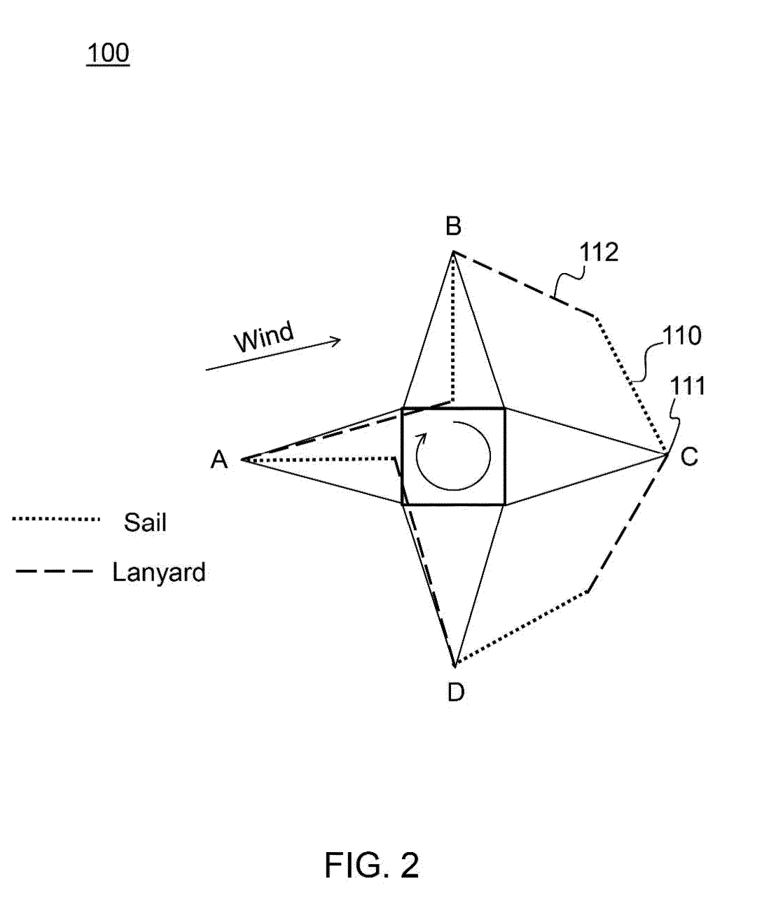

For further understanding, FIG. 2 is an overhead view of the sail assembly 100, looking down at four individual stages of sails 110 in action. Stage A, B, C, and D, are shown to depict the sequence of order that the sails 110 move from one stage to the next. Also depicted is how the lanyards 112 limit the motion of the sails 110 as the lanyard 112 becomes taught and prevents the sail 110 from pivoting further about the sail pivot axis 111.

When the wind is active, four general stages take place, depicted as Stages A, B, C, and D, and further described as follows:
A. Stage-A: The sail is trimmed closed (closed position), in the down wind direction, and in the process for the power stage Stage B).
B. Stage-B: The sail is broadside to the wind, bearing excessive push power in a vigorous and intense rotating mechanical motion into Stage C.
C. Stage-C: By combining centrifugal three with push-power, the sail opens trim, causing no resistance as it comes about into Stage D.
D. Stage-D: The sail continues to remain in an open position, trimmed to the wind, causing no resistance to rotation, then back to Stage A.

Adjusting the angle of pitch that the sails (e.g., square or rectangular sails) in the frames close and open from 90-degree open, to 45-degree closed, at the tip of the parallel and horizontal yardarms, stimulates an increased display of sail activity with a full-scale range of motion that improves the overall performance wind and in water.

It should be understood that the drawings display sails that open and close 90-degree at the tip of yardarms. The sails do actually open to 90-degree at the tip of parallel yardarms, but sails close only 45-degree, to quicken the action. It should also be understood that the degrees described herein are but one non-limiting example of suitable ranges of motion. For example, as can be understood by one skilled in the art, the ranges (i.e., degrees of motion) of the sails can move between any suitable ranges to provide wind capture and sail operation (cg., 42 degrees to 92 degrees, etc.).

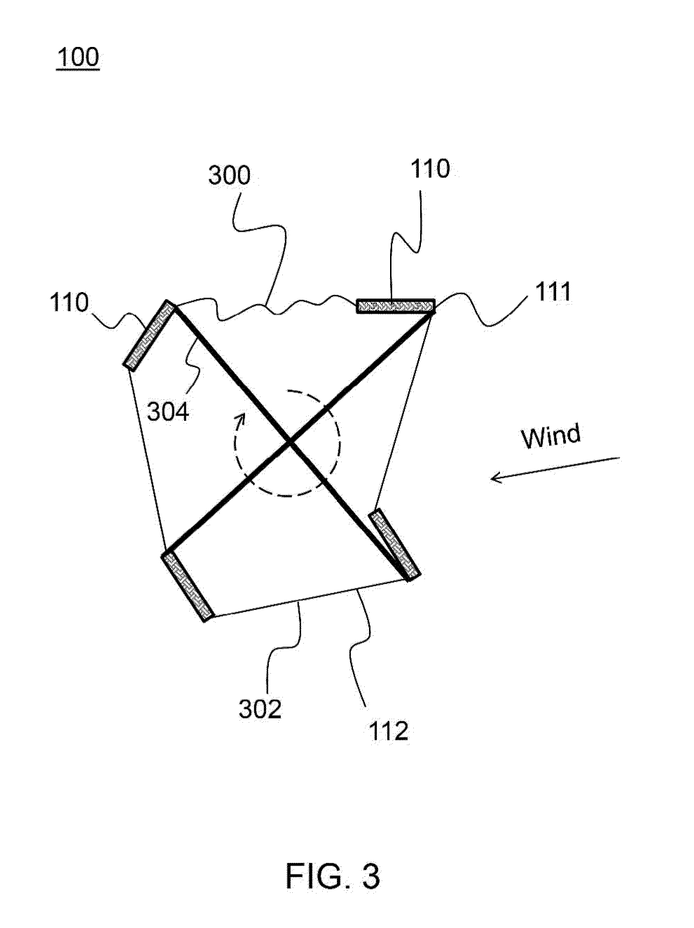

The ability of the sail 110 to pivot about the sail pivot axis 111 allows the wind turbine to efficiently capture wind from any direction. Thus, the sails can adjust to function oppositely making rotation omni-directional, in any wind direction. As shown in FIG. 2, the wind approaches the wind turbine in a first direction. Alternatively and as shown in FIG. 3, the wind approaches the sail assembly 100 of the wind turbine in a second direction which is substantially opposite to the first direction depicted in FIG. 2. Nevertheless, as shown, the sails 110 pivot about the sail pivot axis 111 to capture the wind and rotate the turbine. Also as shown, the lanyards 112 limit to the motion of the sails 110 to efficiently capture the wind. Although not required, the turbine can be formed such that the lanyards 112 are loose 300 in one configuration yet taught 302 in another configuration. For example, when the sail 110 is blown such that it points directly toward the neighboring yardarm 304, the distance between the tip of the sail 110 and the neighboring yardarm 304 is at its smallest, which allows for possible slack on the lanyard 112. Alternatively, if the lanyard is formed of an elastic material or stiff material, it may be the case that the lanyard 112 remains taught in all positions.

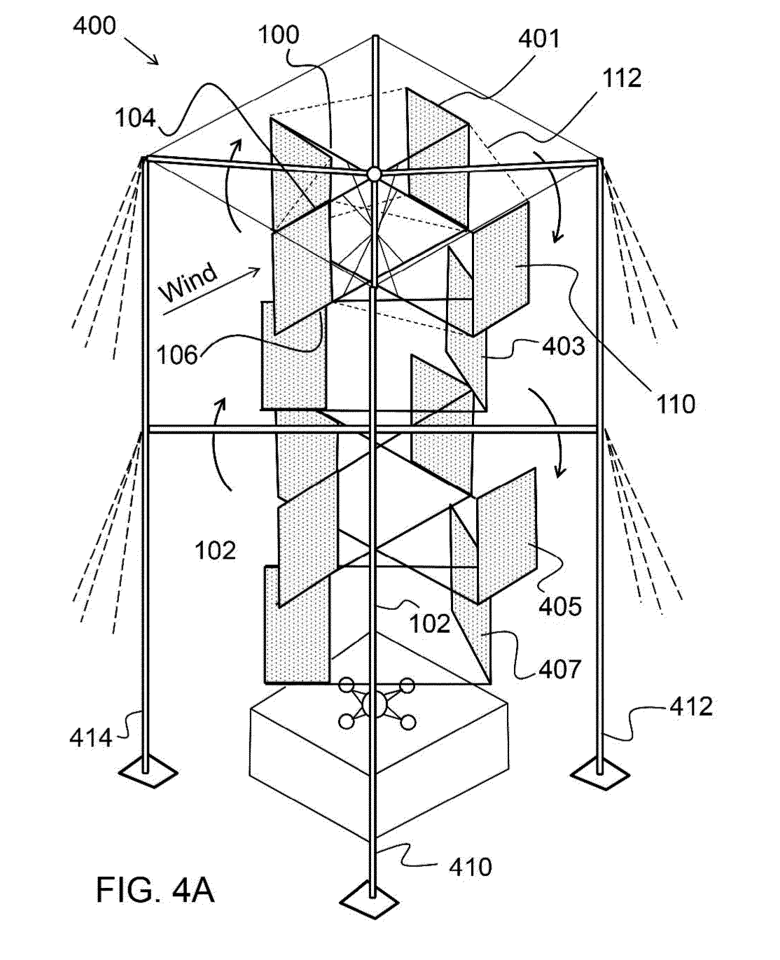

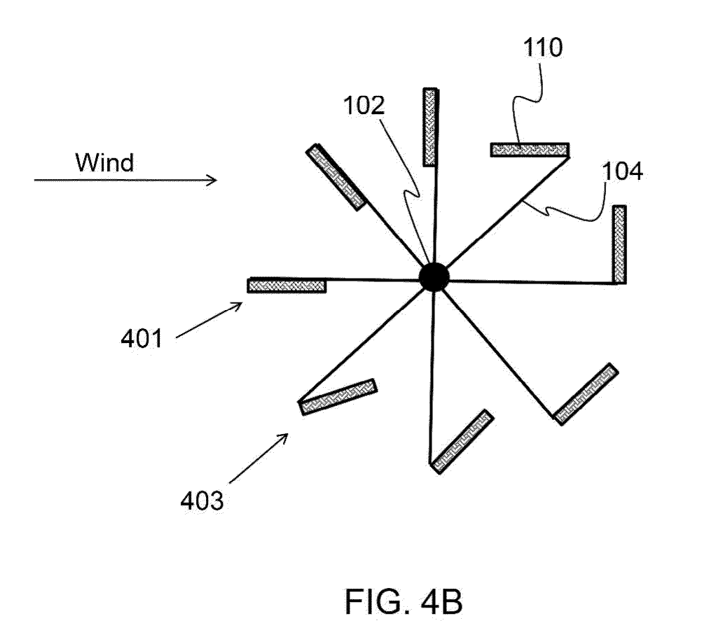

As noted above, the present invention can be employed to use a series of sails configured in a tiered fashion. For example, FIG. 4A is a perspective-view illustration of a wind turbine 400 constructed in accordance with one aspect of the present invention. Although not Limited thereto, FIG. 4A illustrates a four-tier (401, 403, 405, and 407) high arrangement of sail assemblies 100. The sails 110 can be formed in any suitable shape to capture wind and operate as a sail, a non-limiting example of which includes rectangular-shaped sails or square-shaped (rigged) sails.

The sails 110 are pivotally attached with the yardarms to open and close at the tip of parallel horizontal yardarms 104 and 106, demonstrating a continuity of order of sails in action. Each sail 110 relates to the next as they alternate in simultaneous succession against the force of wind pressure in down-wind, and up-wind. directions, respectively. The effect rotates a vertical main shaft 102, to bring about rpm power at ground level. Although illustrated with respect to only the first tier 401, it should be understand that the sails 110 in all tiers (e.g., 403, 405, and 407) include as lanyard 112 that is attached with a neighboring yardarm. It should also be understood that the main shaft 102 is obscured in the figure by a vertical support column 410.

As noted above, multiple tiers with multiple yardarms can be connected with the wind turbine to capture wind energy. For example, FIG. 4B is a top-view illustration of multi-tiered sail assemblies (such as that depicted in FIG. 4A). For example, FIG. 4B illustrates the first tier 401 and second tier 403 sail assembly. FIG. 4B illustrates the effect that wind has on multiple yardarms 104 with pivotally attached sails 110 that pivot by wind force to best capture the wind energy. As described, the sails 110 against wind pressure rotate a vertical main shaft 102 to bring about the effect of rpm power at ground level.

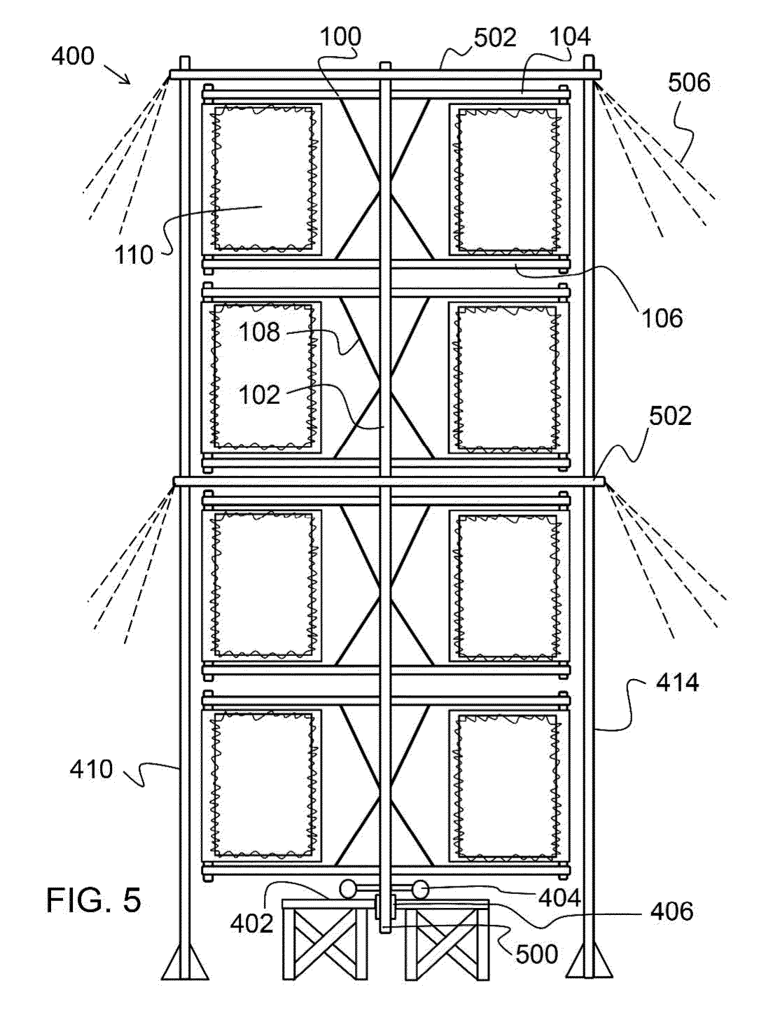

FIG. 5 is a side-view illustration of the wind turbine 400. The example depicted is a four-tiers high construction (each tier having a sail assembly) that includes variable rectangular sails 110 that are attached with the yardarms through pivotal attachment at the tip of parallel and horizontal yardarms 104 and 106, cross-connected and corner braced 108, to the vertical main shaft 102.

The wind turbine 400 includes a main deck 402 that is used to stabilize the structure. A lower end of the vertical main shaft 102 goes through a bearing 404 to equalize stability and gravitate the exerting force revolving on the top surface of a main deck 402. The bearing 404 is any suitable mechanism or device capable of stabilizing the main shaft 102, a non-limiting example of which includes a ball-joint four-roller thrust bearing. The bottom end of the vertical main shaft 102 goes through main bearings 406, then through the center of the main deck 402.

As the main shaft 102 passes through main deck 402, it provides a rotating stem 500 that can be used for power take-off by a power take-off system. Thus, the sails 110 in their sail frames rotate the main shaft 102 to rotate a low, heavy massive base structure to mechanize the enhanced inertial effect.

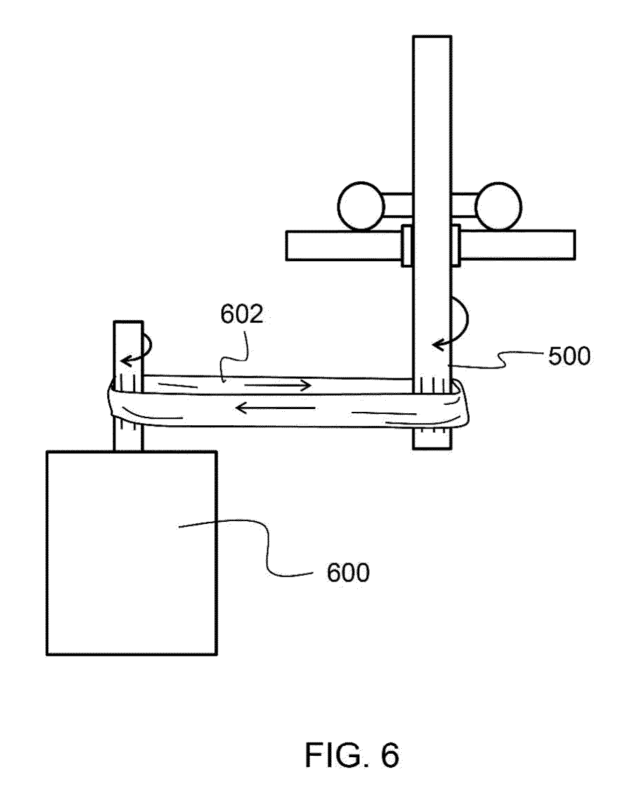

In other words and as depicted in FIG. 6, the power take-off system 600 is any suitable mechanism or device that is capable of converting the rotational forces of the rotating stem 500 into electricity. As a non-limiting example, the power take-off system 600 is an electromagnetic generator can be attached with the stem 500 via as belt system 602 such that as the stem 500 rotates, it causes a current to be formed via magnets and a coil to generate electricity, which can be passed into an electrical grid and/or used with other devices. As yet another example, as gearbox connected to a generator assembly will connect to the wind turbine system and drive the gearbox from the power take-off at the rotating stem 500.

As can be appreciated by one skilled in the art, there are alternative designs for the power take-off For example, although FIG. 4A depicts the power take-off as having a four roller thrust bearing revolving on the top surface of a main deck 402, the present invention is not intended to be limited thereto. Additional variations to the power take-off can be accomplished by means of a vertical main-shaft axis of rotation base in a secure socket resting on rotatable thrust bearings in the socket, and a power take-off gear above the socket to be connected to a gearbox and generator assembly at ground level. Additional configurations can be envisioned by one skilled in the art given the description herein.

As noted above, the present invention can include any suitable number of tiers of rotating sail frame structures. For example and referring again to FIG. 4A, four tiers (401, 403, 405, and 407) of sail frame structures can be employed to capture and harness a tremendous amount of wind energy. In stacking the tiers, a support structure needs to be included maintain the erected wind turbines. As such, the present invention includes a front support column 410, two side support columns 412 and 414, and a rear support column (not illustrated). It should be understood that any suitable number of support columns can be used to maintain stability of the present invention. As shown in FIG. 5, lateral cross-braces 502 are then joined together at the vertical main shaft 102, at the middle and top of the support columns, and coupled by self-aligning split bearings 504 (or any other suitable bearing or roller system).

To further support the turbine 400, guy-wire can be attached with the structure. As a non-limiting example, a three-way guy-wire 506 can be attached in two places on each support column (e.g., 410 and 414), and then anchored to the ground to add support. It should be understood that the support columns can be secured to the base (footing) with or without guy-wires 506, depending on the desired stability and how high the support columns extend above a ground surface.

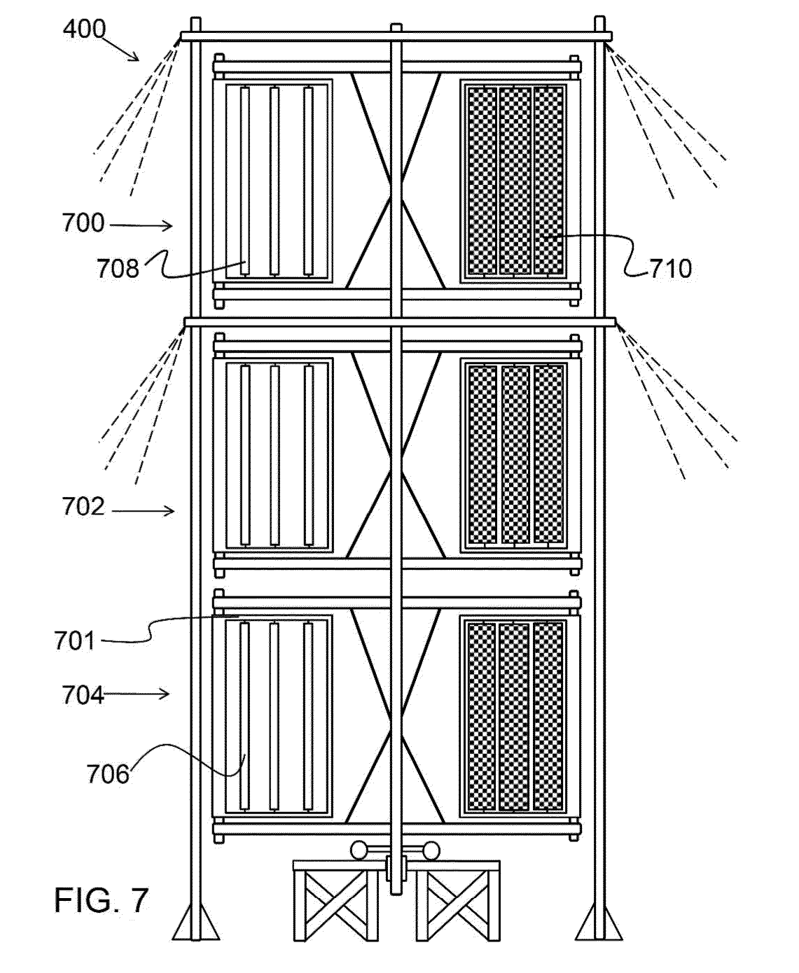

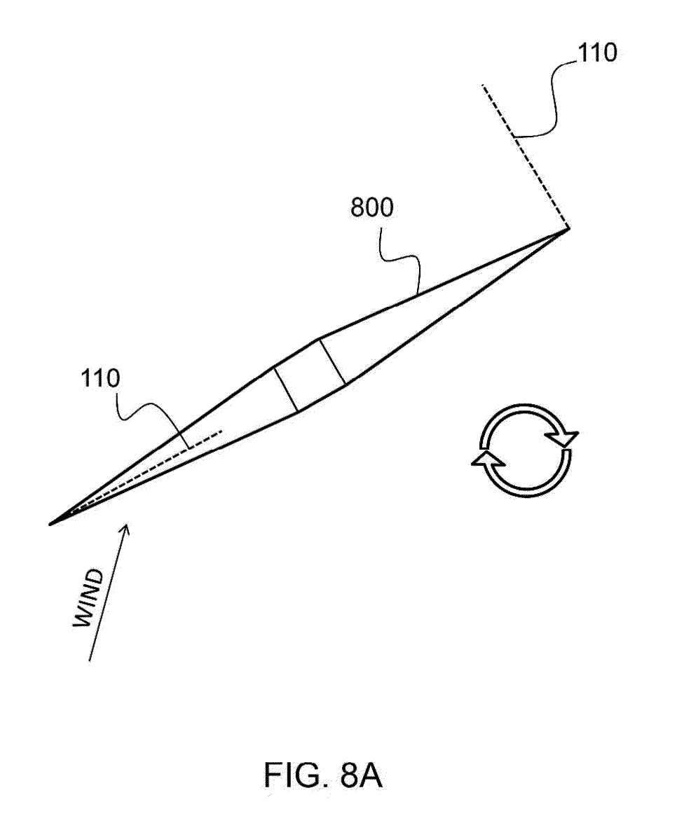

FIG. 7 shows another example, where the turbine 400 includes three-tiers of sail assemblies, shown as tier one 700, tier two 702, and tier three 704. In this example, the wind turbine 400 includes vertical louvers 706 used as rectangular sails in a sail frame 701. Importantly, the vertical louvers 706 can be selectively opened 708 and closed 710 to cause the sails to capture the wind and rotate the corresponding sail assembly. For example, when the vertical louvers 706 are opened 708, wind passes through the sail which prevents the sail assembly from rotating. Alternatively, when the vertical louvers 706 are closed 710, the louvers 706 form the sail and cause the sail to rotate and, thereby, rotate the assembly. The louvers 706 are opened 708 and closed 710 using any suitable mechanism or technique. For example, a motor can be used to drive a chain that runs within the sail frame 701 and connects with ends of each of the louvers 706 (similar to vertical blinds), thereby allowing a system and/or user to selectively open 708 and close 710 the louvers 706.

As yet another non-limiting example, the louvers 706 can be formed to rotate freely, with the exception of a stop that limits their rotation. For example, wind blowing against the louvers 706 will cause the louvers 706 to rotate within the sail frame 701 until they hit a stop. At which point, the louvers 706 are in a closed 710 position, which would cause the sail assembly to rotate. As the sail assembly rotates, at some point, the wind force against the louvers 706 is coming from a different direction, which blows the louvers 706 to an open 708 position. In the open position, the yardarm holding those louvers 706 is free to rotate past until wind catches the louvers 706 again and forces them into a closed 710 position.

A breaking system to stop rotation of the wind turbine will require all sails to remain in a closed position before the breaking system is applied. As a non-limiting example, a lanyard/stop control mechanism and counter can be included such that after an adequate number of rotations have been achieved before servicing, the lanyards or stops will then be moved to allow the sails to fully open. Once fully opened, the sails will not capture wind to act as a sail and, thus, the system will stop rotation.

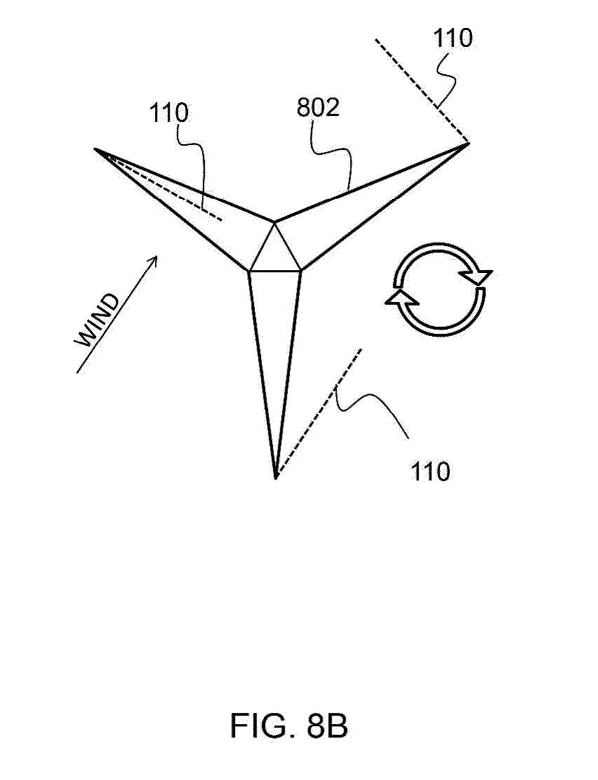

As noted above, the present invention can be applied to any sail configuration. For example, FIG. 4A depicts four sails on each tier of the wind turbine 400. Alternatively, FIGS. 8A and 8B illustrate a two and three sail configuration, respectively. For example, FIG. 8A is a top-view illustration, depicting two sails 110 attached with a two-arm yardarm 800 structure. Also depicted is the wind's impact on the position of the sails 110. As yet another example. FIG. 8B is a top-view illustration, depicting three sails 110 attached with a three-arm yardarm 802 structure and the corresponding wind impact on the sail's 110 position. The configurations depicted in FIGS. 8A and 8B work well in a current of water. The sails open to 90 degree at the tip of parallel horizontal yardarms, then close to 45 degree. This angle of pitch is to advance the sails operating in wind and in water.

In another aspect, the turbine described herein can be a submerged turbine system to be used in an underwater current with a gearbox and generator assembly supported above water. Another aspect of the present invention includes a wind turbine assembly with louver type sails in frames that pivotal attach to parallel horizontal yardarms. In yet another aspect, the wind turbine system includes a floating barge, a gearbox connected to a generator and the wind turbine assembly that drives the gearbox.

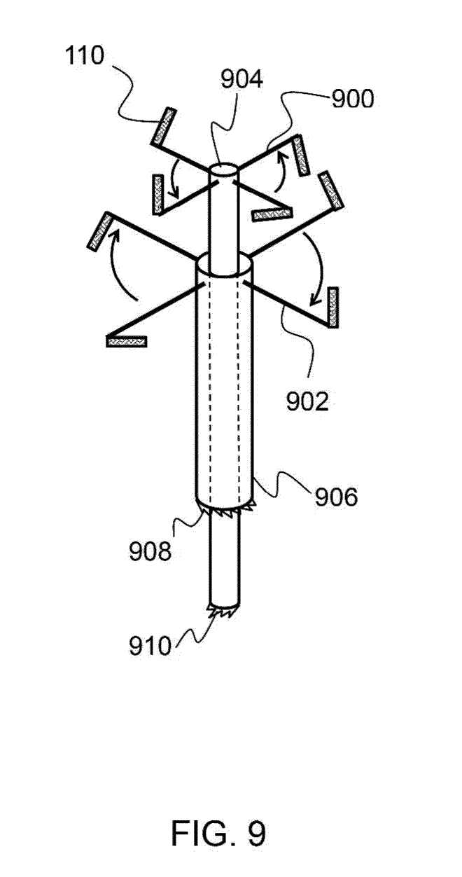

Yet another aspect is depicted in FIG. 9. FIG. 9 is an illustration of opposite counter-rotating rotors with sail assemblies 900 and 902 that rotate in opposite directions and have sails 110 that oscillate freely in an arc of 45 degrees. Each of the sail assemblies 900 and 902 is connected with a main shaft that provides a power take-off. For example, the first sail assembly 900 includes an inner shaft 904 that operates as a rotor and that includes bevel gears 910 that provide a power take-off. Additionally, the second sail assembly 902 has an outer shaft 906 that operates as a rotor and that also includes bevel gears 908. The outer shaft 906 can be hollow to allow the inner shall 904 to pass therethrough. Thus, both assemblies 900 and 902 can double the absolute speed delivered to the planetary or bevel gearbox.

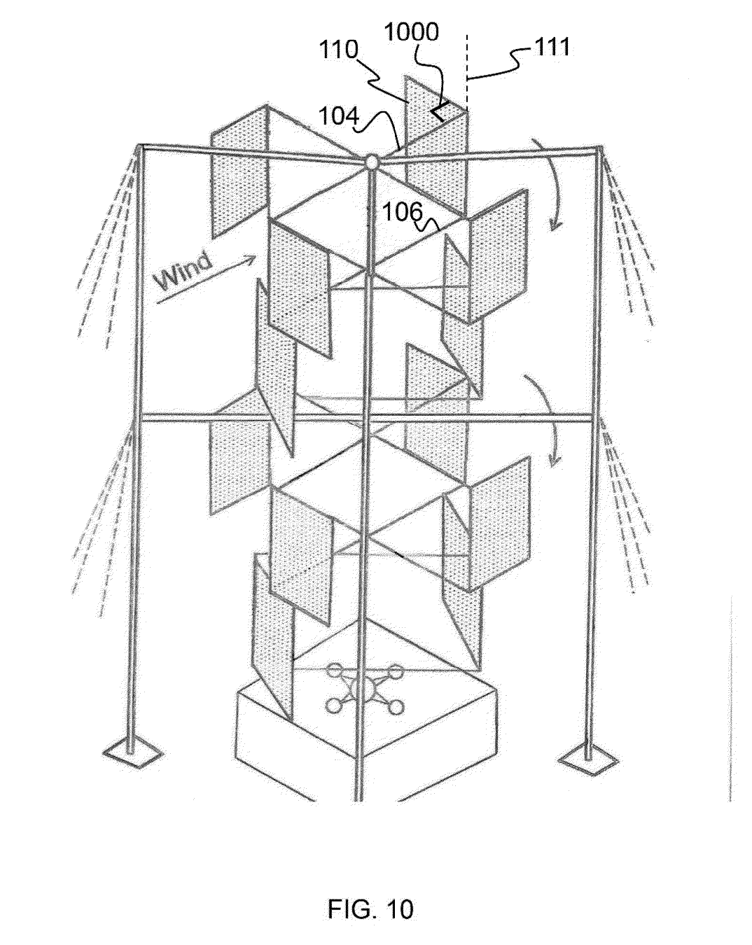

In another aspect and as illustrated in FIG. 10, the sails 110 can be fixed with respect to the yardarms 104 and 106 so that they do not rotate about the sail pivot axis 111. For example, the aspect in FIG. 10 illustrates the sails 110 fixed in a 90 degree position 1000 with respect to yardarms 104 and 106. It should be understood the sails 110 can be fixed at any desired angle with respect to the yardarms 104 and 106, such as being parallel to the yardarms 104 and 106 (such as the position shown in FIG. 5).

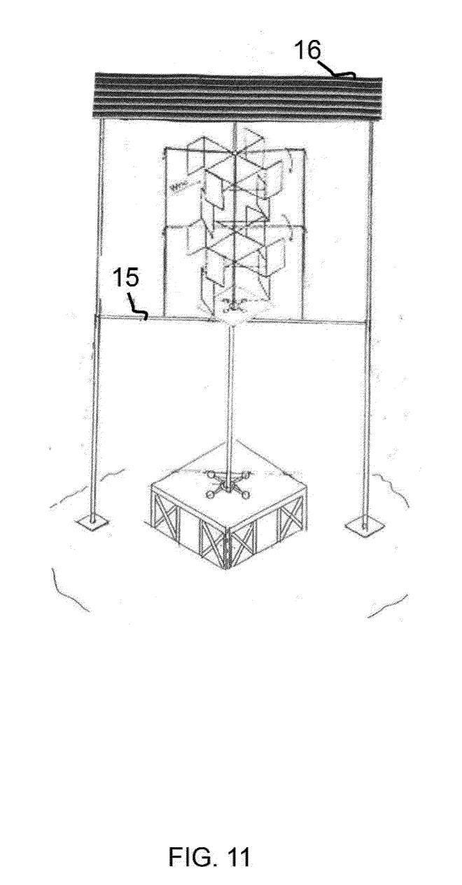

Additionally as shown in FIG. 11, the wind turbine can be elevated from the ground surface so that it protrudes from an upper deck 15. The wind turbines vertical main shaft will protrude through the center of the upper deck 15 down to ground level where it is connected to a generator at ground level for ease of maintenance and servicing. Additionally, a roof 16 (e.g., flat roof or any other shape) can be positioned over the wind turbine. The roof 16 helps to channel wind into the wind turbine. In one non-limiting example, the roof 16 is attached with each of the support columns to cover the wind turbine components.

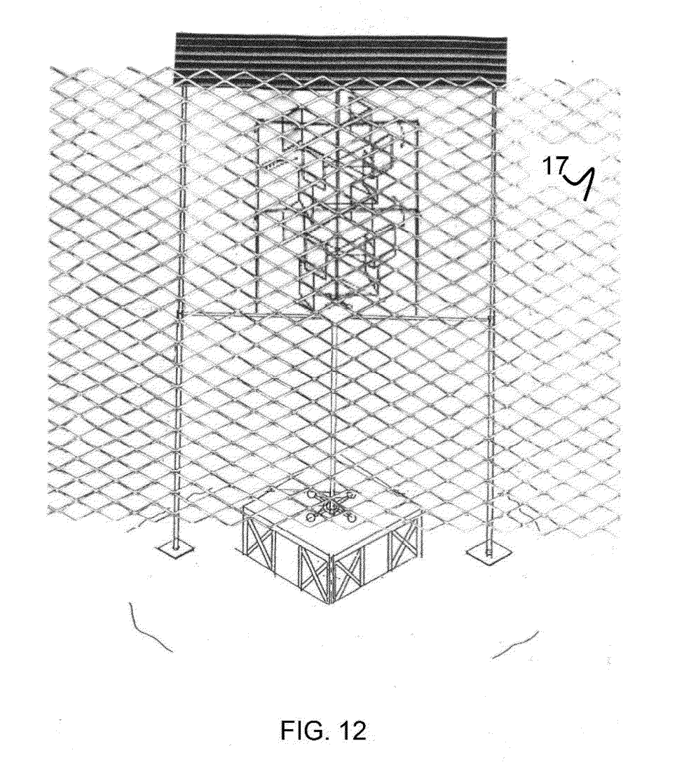

Further and as shown in FIG. 12, fencing 17 can be added to prevent birds and other wildlife from entering the wind turbine. As a non-limiting example, the fencing 17 can be placed around the support columns. The fencing 17 is any desired type of fencing 17 that allows wind to pass there through, a non-limiting example of which includes standard chain link fencing.

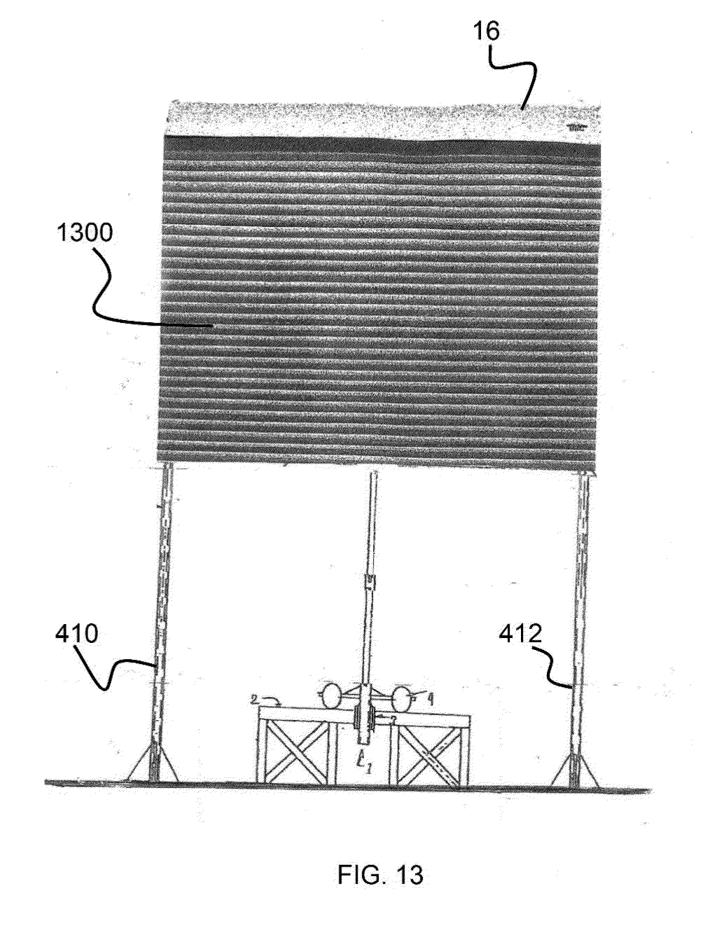

In another aspect and as shown in FIG. 13, roll-up and down doors 1300 (e.g., corrugated roll-up and down doors) can be attached with the system to prevent wind from entering the turbine at times to provide for shut down (via closing the corrugated doors). For example, if the wind turbine has four surrounding support columns 410 and 412 (two of which are illustrated in the side-view illustration of FIG. 13), then four roll-up and down doors 1300 can be attached with the wind turbine. In other words, connecting with and spanning each pair of support columns (e.g., 410 and 412) can be a roll-up and down door 1300. The roll-up and down doors 1300, combined with the roof 16, would allow a user or administrator to effectively prevent all wind from entering the wind turbine if desired.

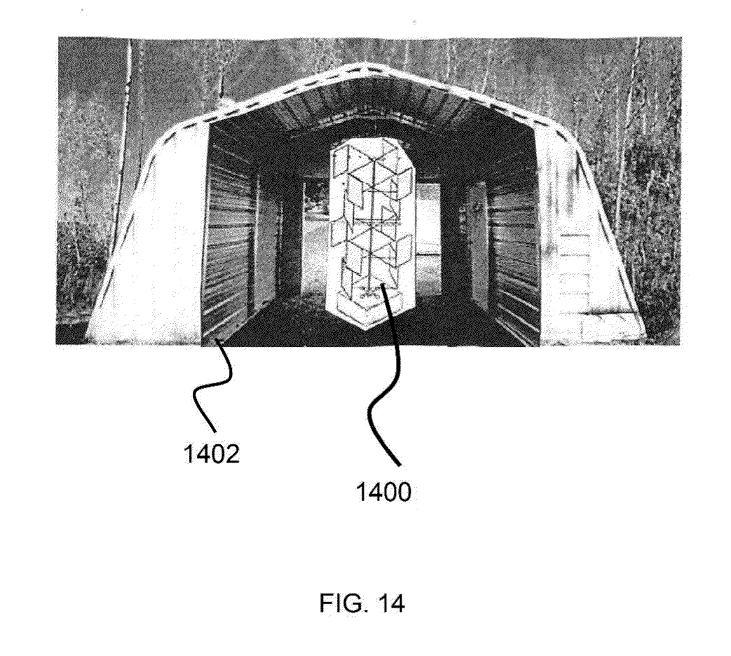

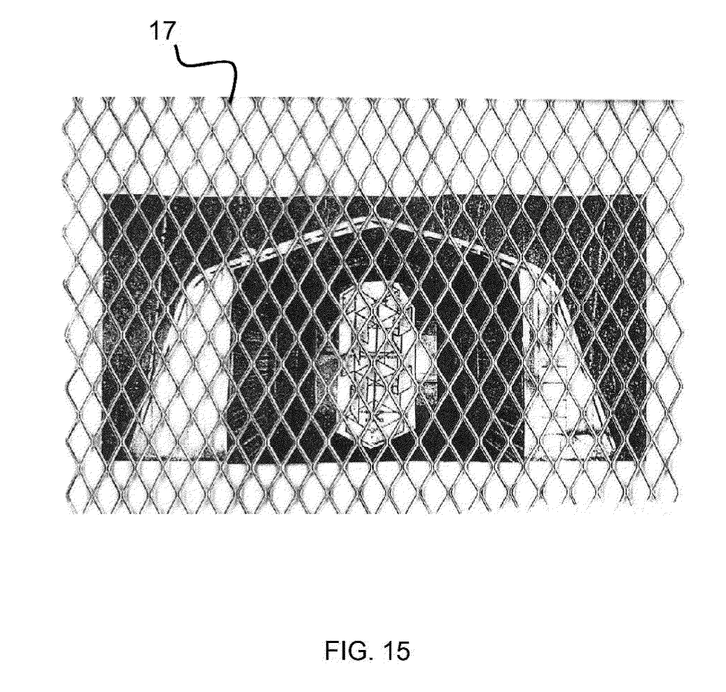

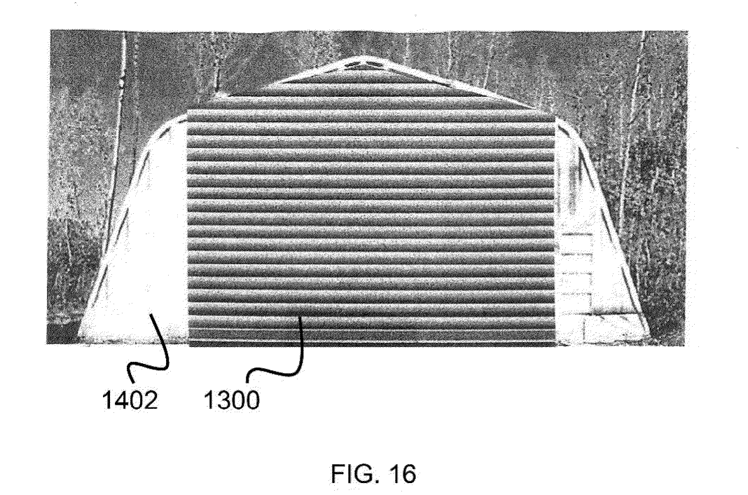

In another aspect and as shown in FIGS. 14-16, the wind turbine 1400 can be positioned within a large enclosure type wind tunnel 1402. The wind tunnel 1402 is any structure that is adapted to contain and allow wind to pass there through, a non-limiting example of which includes a Quonset hut (or Kwanzaa hut) structure.

The wind tunnel 1402 can be constructed above ground or at ground level, with the wind tunnel 1402 open in the front and the rear. The wind tunnel 1402 can also house one or more wind turbines 1400 with fencing 17 to cover the front and the rear openings to keep out wildlife. Corrugated roll-up and down doors 1300 can also be attached at both the front and rear openings of the wind tunnel 1402 that can be closed during shutdown of the wind turbine/s 1400 for maintenance or other purposes.

It should be understood that the specific components described above are provides as a non-limiting example of suitable components and that the invention is not intended to be limited thereto. As a non-limiting example, although four support columns are described and illustrated, the invention can be formed with any desired number of support columns, which can be anchored to the ground with or without guy wires. Or as another example, in the event where a wind turbine is placed inside a wind tunnel, above ground or at ground level, the wind turbine system could be formed so that that are no guy wires attached to the wind turbine or support columns. Thus, as can be appreciated by one skilled in the art, the present invention can be modified with any combination of components to operate as described herein.

What is claimed is:

1. A sail wind turbine system, comprising:
a wind turbine, the wind turbine having a first sail assembly, the first sail assembly including:
a main shaft having a vertical axis of rotation;
a first yardarm connected with and extending horizontally from the main shaft;
a first sail connected with the first yardarm, wherein the sail harnesses power from wind energy to rotate the main shaft.

2. The sail wind turbine system as set forth in claim 1, further comprising a wind tunnel having an entrance and an exit, with the wind turbine positioned within the wind tunnel between the entrance and the exit.

3. The sail wind turbine system as set forth in claim 2, further comprising roll-up and down doors attached with the entrance and exit.

4. The sail wind turbine system as set forth in claim 3, further comprising a second sail connected with the first yardarm such that the main shaft is connected with the first yardarm between with the first and second sails.

5. The sail wind turbine system as set forth in claim 4, further comprising a second yardarm connected with and extending horizontally from the main shaft such that the second yardarm is parallel with respect to the first yardarm, the first and second yardarms collectively forming a first yardarm set, and wherein each of the first and second sails are fixedly connected with and between both the first and second yardarms.

6. The sail wind turbine system as set forth in claim 5, wherein the main shaft includes a shaft stem for providing power take off to a power take off system.

7. The sail wind turbine system as set forth in claim 6, further comprising a second set of parallel yardarms, the second set of parallel yardarms extending from the main shaft approximately perpendicular to the first set of parallel yardarms, and further comprising two sails fixedly connected between each of the yardarms in the second set of parallel yardarms such that the main shaft is connected with the second set of parallel yardarms between each of the two sails.

8. The sail wind turbine system as set forth in claim 7, further comprising a second sail assembly, the second sail assembly having a main shaft connected with the main shaft of the first sail assembly such that the first sail assembly and the second sail assembly share a vertical axis of rotation, and wherein the second sail assembly further comprises two sets of parallel yardarms extending from the main shaft, each set of parallel yardarms having two sails fixedly connected between the parallel yardarms, wherein the first and second sail assemblies form a multiple tiered and stacked wind turbine.

9. The sail wind turbine system as set forth in claim 8, further comprising support columns connected with the vertical main shaft and for anchoring with a ground surface to support the main shaft in a vertical orientation.

10. The sail wind turbine system as set forth in claim 9, further comprising fencing attached around the support columns.

11. The sail wind turbine system as set forth in claim 10, further comprising four roll-up and down doors attached with the support columns.

12. The sail wind turbine system as set forth in claim 1, further comprising support columns connected with the vertical main shaft and for anchoring with a ground surface to support the main shaft in a vertical orientation.

13. The sail wind turbine system as set forth in claim 12, further comprising fencing attached around the support columns.

14. The sail wind turbine system as set forth in claim 12, further comprising four roll-up and down doors attached with the support columns.
